(19) United States
(12) Patent Application Publication
(10) Pub. No.: US 2018/0081096 A1
(43) Pub. Date: Mar. 22, 2018

(54) A COLOR CONVERSION FILM, AND OPTICAL DEVICES

(71) Applicant: MERCK PATENT GMBH, Darmstadt (DE)

(72) Inventor: Eddy CLAES, Hachi Oji (JP)

(73) Assignee: MERCK PATENT GMBH, Darmstadt (DE)

(21) Appl. No.: 15/558,831

(22) PCT Filed: Feb. 18, 2016
(86) PCT No.: PCT/EP2016/000275

§ 371 Date: Sep. 15, 2017

(30) Foreign Application Priority Data
Mar. 17, 2015 (EP) 15000788.8

(51) Int. Cl. G02B 5/20; G02F 1/1335; G02B 26/02

(52) U.S. Cl. CPC G02B 5/206; G02F 1/133621; G02F 1/133514; G02F 2202/36; G02B 26/02; G02F 2001/133614; G02B 5/201

(57) ABSTRACT

The present invention relates to a color conversion film and to a use of the color conversion film in an optical device. The color conversion film comprises a red sub color area which comprises nanosized 1^{st} and 2^{nd} red color converting material and a green sub color area which comprises nanosized 1^{st} and 2^{nd} green color converting material. The invention further relates to an optical device comprising the color conversion film, a light switching element, and a color filter. The invention also relates to method for preparing the color conversion film, and method for preparing the optical device.

### FIELD OF THE INVENTION

The present invention relates to a color conversion film and to a use of the color conversion film in an optical device. The invention further relates to an optical device comprising the color conversion film, a light switching element, and a color filter. The invention also relates to a method for preparing the color conversion film, and method for preparing the optical device.

### BACKGROUND ART

Color conversion films and optical devices comprising the color conversion film are used in a variety of optical applications such as liquid crystal devices.

For example, as described in WO 2010/106704 A1, U.S. Pat. No. 6,809,781 B2, US 2007/0058107 A1, US 2006/0284532 A1, U.S. Pat. No. 7,686,493 B2,

### PATENT LITERATURE

1. WO 2010/106704 A1,
2. U.S. Pat. No. 6,809,781 B2,
3. US 2007/0058107 A1,
4. US 2006/0284532 A1,
5. U.S. Pat. No. 7,686,493 B2,
6. JP 2003-330019 A
7. JP 2006-10728 A
8. JP 3094961 B
9. JP 2006-301632 A

### SUMMARY OF THE INVENTION

However, the inventor newly has found that there is still one or more of considerable problems for which improvement is desired, as listed below.
1. A color conversion film can emit vivid red and green visible light that is suitable for a color filter having at least red, green and blue sub color regions used in an optical device, is desired.
2. A structure of the color conversion film which can reduce the total amount of color converting materials consumption to fabricate the film, is requested.
3. A color conversion film which can provide improved utilization of energy by emitting visible light more intensely in the wavelength ranges of blue, green and red of a color filter of an optical device is desired.
4. A color conversion film having higher out-coupling efficiency is required.

The inventor aimed to solve one or more of the above mentioned problems. Surprisingly, the inventor has found a novel color conversion film (100) comprising a red sub color area (110), green sub color area (120), and blue sub color area (130), wherein the red sub color area (110), green sub color area (120), and blue sub color area (130) are each independently or commonly surrounded by a bank (140), wherein the red sub color area (110) comprises nanosized 1^{st} red color converting material (111) and nanosized 2^{nd} red color converting material (112); the green sub color area (120) comprises nanosized 1^{st} green color converting material (121) and nanosized 2^{nd} green color converting material (122); and the blue sub color area (110) does not contain any blue color converting material, wherein the 2^{nd} red color converting material (112) emits light having a longer peak wavelength than the peak wavelength of the light from the 1^{st} red color converting material when it is excited; and the 2^{nd} green color converting material (122) emits light having a longer peak wavelength than the peak wavelength of the light from the 1^{st} green color converting material when it is excited, solves the problems 1 to 3 at the same time.

In another aspect, the invention relates to use of the color conversion film (100) in an optical device.

In another aspect, the invention further relates to an optical device (160), including the color conversion film (100) comprising a red sub color area (110), a green sub color area (120), and a blue sub color area (130); a light switching element (170); and a color filter (180); wherein the red sub color area (110), green sub color area (120), and blue sub color area (130) are each independently or commonly surrounded by a bank (140), wherein the red sub color area (110) comprises nanosized 1^{st} red color converting material (111) and nanosized 2^{nd} red color converting material (112); the green sub color area (120) comprises nanosized 1^{st} green color converting material (121) and nanosized 2^{nd} green color converting material (122); and the blue sub color area (110) does not contain any blue color converting material, wherein the 2^{nd} red color converting material (112) emits light having longer peak wavelength than the peak wavelength of the light from the 1^{st} red color converting material when it is excited; and the 2^{nd} green color converting material (122) emits light having longer peak wavelength than the peak wavelength of the light from the 1^{st} green color converting material when it is excited.

In another aspect, the invention furthermore relates to method for preparing the color conversion film (100), wherein the method comprises the following sequential steps of:

(a) preparing a red ink comprising nanosized 1^{st} red color converting material (111) and nanosized 2^{nd} red color converting material (112), and solvent; and a green ink comprising nanosized 1^{st} green color converting material (121) and nanosized 2^{nd} green color converting material (122), and solvent;

(b) providing the resulting inks from step (a) onto the red sub color area (110), and green sub color area (120); and

(c) evaporating the solvent in the coated inks to provide the color conversion film (100).

In another aspect, the invention relates to method for preparing the optical device (160), wherein the method comprises the following step (x):

(x) providing the color conversion film (100) into the optical device (160).

Further advantages of the present invention will become evident from the following detailed description.

### DESCRIPTION OF DRAWINGS

FIG. 1: shows a cross sectional view of a schematic of a color conversion film (100) of the present invention.

FIG. 2: shows a cross sectional view of a schematic of one embodiment of an optical device having a color conversion film of the invention.

FIG. 3: shows a cross sectional view of a schematic of another embodiment of an optical device having a color conversion film of the invention.

FIG. 4: shows a schematic of another embodiment of an optical device of the invention.

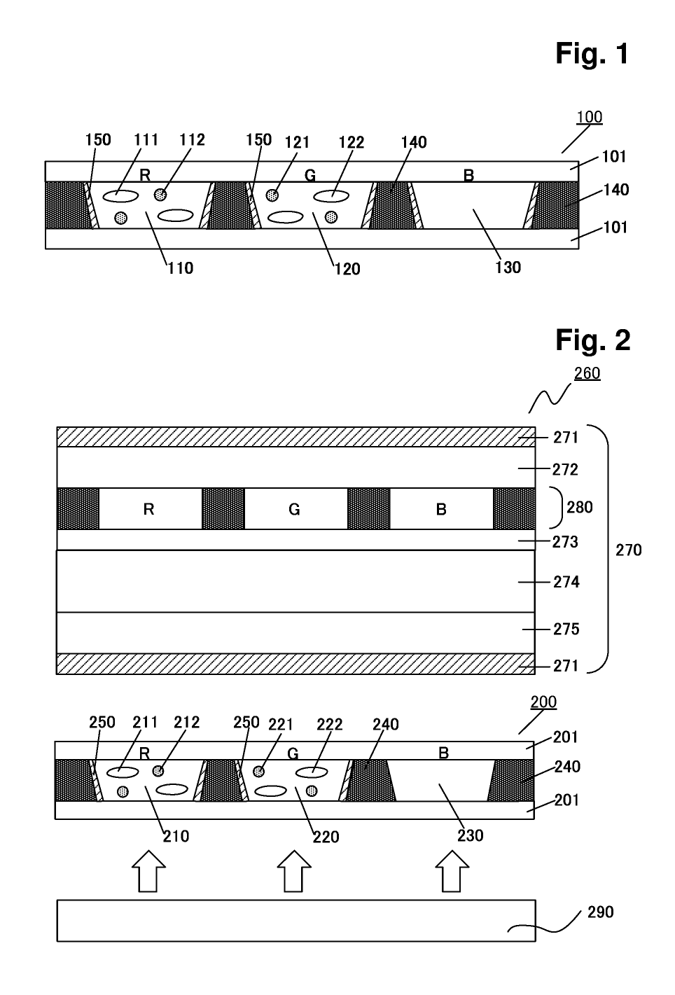

### LIST OF REFERENCE SIGNS IN FIG. 1

100. a color conversion film
101. a passivation layer (optional)
110. a red sub color area
111. 1^{st} red color converting material
112. 2^{nd} red color converting material
120. a green sub color area
121. 1^{st} green color converting material
122. 2^{nd} green color converting material
130. a blue sub color area
140. a bank
150. a reflection layer (optional)

### LIST OF REFERENCE SIGNS IN FIG. 2

200. a color conversion film
201. a passivation layer (optional)
210. a red sub color area
211. 1^{st} red color converting material
212. 2^{nd} red color converting material
220. a green sub color area
221. 1^{st} green color converting material
222. 2^{nd} green color converting material
230. a blue sub color area
240. a bank
250. a reflection layer (optional)
260. an optical device
270. a light switching element (a liquid crystal element)
271. a polarizer (optional)
272. a transparent substrate (optional)
273. an upper transparent electrode
274. a liquid crystal layer
275. a transparent substrate having pixel electrodes
280. a color filter
290. a blue light source (optional)

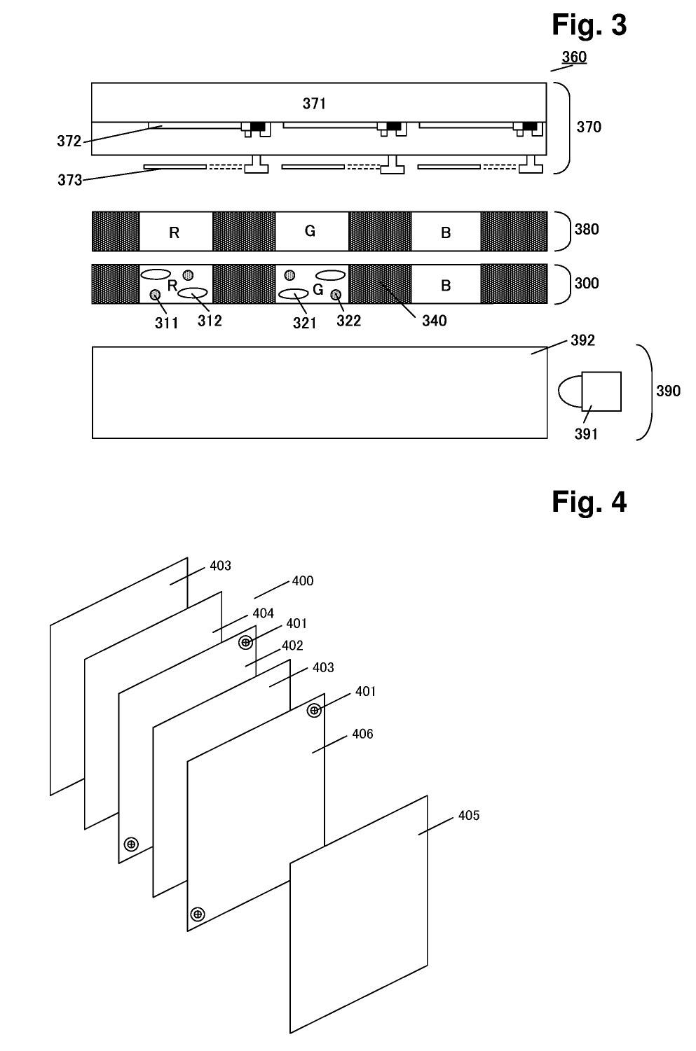

### LIST OF REFERENCE SIGNS IN FIG. 3

300. a color conversion film
311. 1^{st} red color converting material
312. 2^{nd} red color converting material
321. 1^{st} green color converting material
322. 2^{nd} green color converting material
340. a bank
360. an optical device
370. a light switching element
371. a transparent substrate
372. a TFT (Thin film transistor)
373. MEMS (Micro Electro Mechanical Systems) Shutter
380. a color filter
390. a blue light source (optional)
391 a blue LED
392. a light guiding plate (optional)

### LIST OF REFERENCE SIGNS IN FIG. 4

400. an optical device
401. an alignment marker
402. a back plane glass
403. a polarizer
404. a color filter
405. a blue light source
406. a color conversion film

### DETAILED DESCRIPTION OF THE INVENTION

In a general aspect, a color conversion film (100) comprising a red sub color area (110), green sub color area (120), and blue sub color area (130), wherein the red sub color area (110), green sub color area (120), and blue sub color area (130) are each independently or commonly surrounded by a bank (140), wherein the red sub color area (110) comprises nanosized 1^{st} red color converting material (111) and nanosized 2^{nd} red color converting material (112); the green sub color area (120) comprises nanosized 1^{st} green color converting material (121) and nanosized 2^{nd} green color converting material (122); and the blue sub color area (110) does not contain any blue color converting material, wherein the 2^{nd} red color converting material (112) emits light having a longer peak wavelength than the peak wavelength of the light from the 1^{st} red color converting material when it is excited; and the 2^{nd} green color converting material (122) emits light having a longer peak wavelength than the peak wavelength of the light from the 1^{st} green color converting material when it is excited.

According to the present invention, the term “Nanosize” means the size in between 1 nm and 900 nm.

Thus, according to the present invention, the nanosized color converting material is taken to mean that the color converting material which size of the overall diameter of the color converting material is in the range from 1 nm to 900 nm. And in case of the material has elongated shape, the length of the overall structures of the color converting material is also in the range from 1 nm to 900 nm.

For the purpose of the present invention, the term “Blue” is taken to mean a light wavelength in between 380 nm and 499 nm.

Preferably, it is in between 420 nm and 490 nm. More preferably, it is in between 425 nm and 466 nm.

According to the present invention, the term “Green” means a light wavelength in between 500 nm and 594 nm.

Preferably, it is in between 510 nm and 580 nm. More preferably, it is in between 515 nm and 550 nm.

For the purpose of the present invention, the term “Red” is taken to mean that a light wavelength in between 595 nm and 700 nm.

In the preferred embodiment of the present invention, it is in between 600 nm and 680 nm. More preferably, it is in between 610 nm and 640 nm.

According to the present invention, the term “longer” means at least 5 nm difference or more.

Without wishing to be bound by theory, it is believed that “the red sub color area (110) comprising nanosized 1^{st} red color converting material (111) and nanosized 2^{nd} red color converting material (112), wherein the 2^{nd} red color converting material (112) emits light having longer peak wavelength than the peak wavelength of the light from the 1^{st} red color converting material when it is excited” may lead to improved utilization of energy by emitting visible red light more intensely and can emit vivid red visible light that is suitable for a red reason of a color filter of an optical device.

And without wishing to be bound by theory, “the green sub color area (120) comprising nanosized 1^{st} green color converting material (121) and nanosized 2^{nd} green color converting material (122), wherein the 2^{nd} green color converting material (122) emits light having longer peak wavelength than the peak wavelength of the light from the 1^{st} green color converting material when it is excited” may lead to improved utilization of energy by emitting visible green light more intensely and can emit vivid green visible light that is suitable for a green reason of a color filter of an optical device.

In some embodiments of the present invention, the peak wavelength of the light emission from the nanosized 1^{st} and 2^{nd} red color converting materials are in the range from 610 nm to 640 nm; the peak wavelength of the light emission from the nanosized 1^{st} and 2^{nd} green color converting materials are in the range from 515 nm to 550 nm.

According to the present invention, preferably, the peak light wavelength of the 2^{nd} nanosized color converting material is 5 nm or more longer than the peak light wavelength of the nanosized 1^{st} red color converting material and the peak wavelength of the light emission from the nanosized 1^{st} and 2^{nd} red color converting materials are both in the range from 610 nm to 640 nm. More preferably, the peak light wavelength of the 2^{nd} nanosized color converting material is approximately 10 nm longer than the peak light wavelength of the nanosized 1^{st} red color converting material.

In a preferred embodiment of the present invention, the peak light wavelength of the nanosized 2^{nd} green color converting material is 5 nm or more longer than the peak light wavelength of the nanosized 1^{st} green color converting material and the peak wavelength of the light emission from the nanosized 1^{st} and 2^{nd} green color converting materials are in the range from 515 nm to 550 nm. More preferably, the peak light wavelength of the nanosized 2^{nd} green color converting material is approximately 10 nm longer than the peak light wavelength of the nanosized 1^{st} green color converting material.

According to the present invention, the peak wavelength of the light emission from the nanosized color converting material can be measured with using the luminance meter, such as CS-1000 A (Konica Minolta Holdings Inc.).

According to the present invention, the nanosized color converting materials having less than 50 nm of full width at half maximum (hereafter “FWHM”) can be used preferably.

In some embodiments of the present invention, the nanosized 1^{st} red color converting material (111), nanosized 2^{nd} red color converting material (112), nanosized 1^{st} green color converting material (121), and nanosized 2^{nd} green color converting material (122) are each independently selected from the group consisting of an inorganic fluorescent semiconductor quantum rod, inorganic fluorescent semiconductor quantum dot, and a combination of any of these.

As an inorganic fluorescent semiconductor quantum dot (hereafter “quantum dot”), publically available quantum dot, for examples, CdSeS/ZnS alloyed quantum dots product number 753793, 753777, 753785, 753807, 753750, 753742, 753769, 753866, InP/ZnS quantum dots product number 776769, 776750, 776793, 776777, 776785, PbS core-type quantum dots product number 747017, 747025, 747076, 747084, or CdSe/ZnS alloyed quantum dots product number 754226, 748021, 694592, 694657, 694649, 694630, 694622 from Sigma-Aldrich, can be used preferably as desired.

In a preferred embodiment of the present invention, at least one of nanosized color converting material out of the group consisting of the nanosized 1^{st} red color converting material (111), nanosized 2^{nd} red color converting material (112), nanosized 1^{st} green color converting material (121), and nanosized 2^{nd} green color converting material (122), can be selected from an inorganic fluorescent semiconductor quantum rod (hereafter, “quantum rod”).

Without wishing to be bound by theory, it is believed that light luminescence from dipole moment of the light converting material having elongated shape may lead to higher out-coupling efficiency than the out-coupling efficiency of spherical light emission from quantum dot, organic fluorescent material, and/or organic phosphorescent material, phosphor material. In other words, it is believed that the long axis of the nanosized light converting materials having elongated shape such as quantum rods can align parallel to a substrate surface on average with higher probability and their dipole moments also can align parallel to the substrate surface on average with higher probability.

Thus, more preferably, the nanosized 1^{st} red color converting material (111), nanosized 2^{nd} red color converting material (112), nanosized 1^{st} green color converting material (121), and nanosized 2^{nd} green color converting material (122) can be a quantum rod to realize better out-coupling effect with sharp vivid color(s) of the device.

In some embodiments of the present invention, the quantum rod material can be selected from the group consisting of II-VI, III-V, or IV-VI semiconductors and combinations of any of these.

More preferably, the quantum rod material can be selected from the groups consisting of Cds, CdSe, CdTe, ZnS, ZnSe, ZnTe, ZnO, GaAs, GaP, GaAs, GaSb, HgS, HgSe, HgSe, HgTe, InAs, InP, InSb, AIAs, AIP, AlSb, Cu₂S, Cu₂Se, CuInS₂, CuInSe₂, Cu₂(ZnSn)S₄, Cu₂(InGa)S₄, TiO₂ alloys and combination of any of these.

For example, for red emission use, CdSe rods, CdSe dot in CdS rod, ZnSe dot in CdS rod, CdSe/ZnS rods, InP rods, CdSe/CdS rods, ZnSe/CdS rods or combination of any of these. For green emission use, such as CdSe rods, CdSe/ZnS rods, or combination of any of these.

Examples of quantum rod material have been described in, for example, the international patent application laid-open No. WO2010/095140A.

In a preferred embodiment of the invention, the length of the overall structures of the quantum rod material is from 8 nm to 500 nm. More preferably, from 10 nm to 160 nm. The overall diameter of the said quantum rod material is in the range from 1 nm to 20 nm. More particularly, it is from 1 nm to 10 nm.

In a preferred embodiment of the present invention, the quantum rods additionally can comprise a surface ligand.

The surface of the quantum rod materials can be over coated with one or more kinds of surface ligands.

Without wishing to be bound by theory it is believed that such surface ligands may lead to disperse the quantum rod material in a solvent more easily.

The surface ligands in common use include phosphines and phosphine oxides such as Trioctylphosphine oxide (TOPO), Trioctylphosphine (TOP), and Tributylphosphine (TBP); phosphonic acids such as Dodecylphosphonic acid (DDPA), Tridecylphosphonic acid (TDPA), Octadecylphosphonic acid (ODPA), and Hexylphosphonic acid (HPA); amines such as Dedecyl amine (DDA), Tetradecyl amine (TDA), Hexadecyl amine (HDA), and Octadecyl amine (ODA), thiols such as hexadecane thiol and hexane thiol; mercapto carboxylic acids such as mercapto propionic acid and mercaptoundecanoicacid; and a combination of any of these.

Examples of surface ligands have been described in, for example, the international patent application laid-open No. WO 2012/059931A.

In some embodiments of the present invention, optionally, the color conversion film (100) can comprise a transparent substrate.

In general, transparent substrate can be flexible, semi-rigid or rigid.

Publically known transparent substrate suitable for optical devices can be used as desired.

Preferably, as a transparent substrate, a transparent polymer substrate, glass substrate, thin glass substrate stacked on a transparent polymer film, transparent metal oxides (for example, oxide silicone, oxide aluminum, oxide titanium), can be used.

A transparent polymer substrate can be made from polyethylene, ethylene-vinyl acetate copolymer, ethylene-vinyl alcohol copolymer, polypropylene, polystyrene, polymethyl methacrylate, polyvinylchloride, polyvinyl alcohol, polyvinylvutyral, nylon, polyether ether ketone, polysulfone, polyether sulfone, tetrafluoroethylene-erfluoroalkylvinyl ether copolymer, polyvinyl fluoride, tetraflyoroethylene ethylene copolymer, tetrafluoroethylene hexafluoro polymer copolymer, or a combination of any of these.

The term “transparent” means at least around 60% of incident light transmittal at the thickness used in a photovoltaic device and at a wavelength or a range of wavelength used during operation of photovoltaic cells. Preferably, it is over 70%, more preferably, over 75%, the most preferably, it is over 80%.

In a preferred embodiment of the present invention, the red sub color area (110), green sub color area (120), and blue sub color area (130) of the color converting film (100) can further comprises a matrix material.

As the matrix material according to the present invention, any type of publically known transparent matrix material suitable for optical films can be used as desired, because, the matrix material better to have good processability in fabrication of the sub color areas of the color converting film (100), and has long-term durability.

In a preferred embodiment of the present invention, a photo-curable polymer, and/or photo-sensitive polymer can be used. For example, acrylate resins used in LCD color filter, any photo-curable polysiloxane, a polyvinylcinnamate widely used as a photo-curable polymer or a combination of any of these.

According to the present invention, generally, the bank (140) can be fabricated with well-known technique with publically known material used for optical films.

Without wishing to be bound by theory, it is believed that the surrounded bank may determine the limit of the sub color areas of the color conversion film (100) and can reduce the amount of material consumption to fabricate the color conversion film (100) compared with existing color conversion films.

In some embodiments of the present invention, the bank (140) has a tapered shape like described in FIG. 1.

In some embodiments of the present invention, optionally, the polarized light emissive device (100) further comprises a black matrix (hereafter “BM”).

In a preferred embodiment, the bank can be made from black matrix (hereafter “BM”) like described in FIG. 1.

A material for the BM is not particularly limited. Well known materials, especially well known BM materials for color filters can be used preferably as desired. Such as black dye dispersed polymer composition, like described in WO 2008/123097A, WO 2013/031753A.

Fabrication method of the BM is not particularly limited, well known techniques can be used in this way. Such as, direct screen printing, photolithography, vapor deposition with mask.

In some embodiments of the present invention, the bank (140) has a reflective layer (150) directly placed on the surface of the bank.

In a preferred embodiment of the present invention, the bank (14) has a tapered shape, and the bank has a reflective layer (150) directly placed on the surface of the bank.

In some embodiments of the present invention, the color conversion film (100) comprises one or more of alignment maker.

In some embodiments of the present invention, optionally, the color converting film (100) further comprises a transparent passivation film. Without wishing to be bound by theory it is believed that such a transparent passivation film may lead to an increased protection for the color converting materials and/or the color conversion film (100).

Preferably, the transparent passivation layer fully or partially covers the color converting film (100), or the color converting film (100) can be put between two transparent passivation films.

More preferably, the transparent passivation film fully covers the color converting film (100) like to encapsulate, or it can sandwich the color converting film (100) can be sandwiched by two transparent passivation films.

In general, the transparent passivation film can be flexible, semi-rigid or rigid.

The transparent material for the transparent passivation film is not particularly limited. In a preferred embodiment, the transparent passivation film is selected from the group consisting of a transparent polymer layer, transparent metal oxide layer (for example, oxide silicone, oxide aluminum, oxide titanium) as described above in the transparent substrate.

In general, the methods of preparing the transparent passivation film can vary as desired and selected from well-known techniques.

In a preferred embodiments, the transparent passivation film can be prepared by a gas phase based coating process (such as Sputtering, Chemical Vapor Deposition, vapor deposition, flash evaporation), or a liquid-based coating process.

In some embodiments of the present invention, optionally, the color conversion film (100) can further comprise a light guide plate on at least one side of the film. Preferably, the light guide plate is placed onto the surface of the color conversion film (100) to realize uniform light emissions from each sub color pixels.

In another aspect of the present invention, the invention relates to use of the color conversion film (100) in an optical device.

In a preferred embodiment of the present invention, the color conversion film (100) can be used in the optical device selected from the group consisting of a liquid crystal display, MEMS display, electro wetting display, and electrophoretic display.

More preferably, the optical device can be a liquid crystal display. Such as twisted nematic liquid crystal display, vertical alignment mode liquid crystal display, IPS mode liquid crystal display, guest host mode liquid crystal display, and the normally black TN mode liquid crystal display.

Examples of optical devices have been described in, for example, WO 2010/095140 A2 and WO 2012/059931 A1.

In another aspect, the invention further relates to an optical device (160), comprising the color conversion film (100) including a red sub color area (110), green sub color area (120), and blue sub color area (130); a light switching element (170); and a color filter (180); wherein the red sub color area (110), green sub color area (120), and blue sub color area (130) are each independently or commonly surrounded by a bank (140), wherein the red sub color area (110) comprises nanosized 1^{st} red color converting material (111) and nanosized 2^{nd} red color converting material (112); the green sub color area (120) comprises nanosized 1^{st} green color converting material (121) and nanosized 2^{nd} green color converting material (122); and the blue sub color area (110) does not contain any blue color converting material, wherein the 2^{nd} red color converting material (112) emits light having longer peak wavelength than the peak wavelength of the light from the 1^{st} red color converting material when it is excited; and the 2^{nd} green color converting material (122) emits light having longer peak wavelength than the peak wavelength of the light from the 1^{st} green color converting material when it is excited.

In some embodiments of the present invention, the electro optical device (160) further comprises a blue light source (190).

The type of blue light source in the optical device is not particularly limited.

For example, blue LED, CCFL, EL, OLED, or a combination of any of these, can be used.

More preferably, the light source emits light having peak wavelength in the range from 425 nm to 466 nm, such as blue LED.

Without wishing to be bound by theory it is believed that the blue LEDs having a peak wavelength in the range from 425 nm to 466 nm may lead improved utilization of energy by emitting visible vivid blue light more intensely in the wavelength ranges of blue of the color filter used in the optical device (160).

Furthermore preferably, the light source emits light having peak wavelength in the range from 440 nm to 466 nm. Therefore, in some embodiments of the present invention, the peak wavelength of the light emission from the blue light source (190) is in the range from 425 nm to 466 nm.

In a preferred embodiment of the present invention, additionally, the blue light source (190) can comprise a light guide plate to increase light uniformity from the blue light source (190).

According to the present invention, as the color filter (180), any type of publically known color filter having red, green and blue sub color region for optical devices, such as LCD color filter, can be used in this way.

In a preferred embodiment of the present invention, the red sub color region of the color filter is transparent to light wavelength at least in between 610 and 640 nm, and the green sub color region of the color filter is transparent to the light wavelength at least in between 515 and 550 nm.

In a preferred embodiment of the present invention, the light switching element (170) can be selected from the group consisting of liquid crystal element, Micro Electro Mechanical Systems (here in after “MEMS”), electro wetting element, and electrophoretic element.

Therefore, in some embodiment of the present invention, the light switching element (170) is selected from the group consisting of a liquid crystal element, Micro Electro Mechanical Systems, electro wetting element, and electrophoretic element.

In the case of the electro optical switching element (170) is a liquid crystal element, any type of publically known liquid crystal element can be used in this way preferably.

For example, twisted nematic mode, vertical alignment mode, IPS mode, normally black TN mode, guest host mode liquid crystal element, which commonly used for LCDs are preferable.

In a preferred embodiment of the present invention, the electro optical switching element (170) can comprise one or more of alignment marker. The alignment marker can be used to align the color conversion film

In some embodiments of the present invention, optionally, the blue light source (190) is switchable.

According to the present invention, the term “switchable” means that the light can selectively be switched on or off.

In a preferred embodiment of the present invention, the switchable light source can be a plural of blue LEDs.

In some embodiments of the present invention, optionally, the light switching element (170) further comprises a selective light reflection layer placed in between the blue light source (190) and the color conversion film (100).

According to the present invention, the term “light reflection” means reflecting at least around 60% of incident light at a wavelength or a range of wavelength used during operation of a polarized light emissive device. Preferably, it is over 70%, more preferably, over 75%, the most preferably, it is over 80%.

A material for the selective light reflection layer is not particularly limited. Well known materials for a selective light reflection layer can be used preferably as desired.

According to the present invention, the selective light reflection layer can be a single layer or multiple layers.

In a preferred embodiment, the selective light reflection layer is selected from the group consisting of Al layer, Al+MgF₂ stacked layers, Al+SiO stacked layers, Al+dielectric multiple layer, Au layer, dielectric multiple layer, Cr+Au stacked layers; with the selective light reflection layer more preferably being Al layer, Al+MgF₂ stacked layers, Al+SiO stacked layers, cholesteric liquid crystal layer, stacked cholesteric liquid crystal layers.

Examples of cholesteric liquid crystal layers have been described in, for example, the international patent application laid-open No. WO 2013/156112A, WO 2011/107215 A.

In general, the methods of preparing the selective light reflection layer can vary as desired and selected from well-known techniques.

In some embodiments, the selective light reflection layer expect for cholesteric liquid crystal layers can be prepared by a gas phase based coating process (such as Sputtering, Chemical Vapor Deposition, vapor deposition, flash evaporation), or a liquid-based coating process.

In case of the cholesteric liquid crystal layers, can be prepared by method described in, for example, WO 2013/156112A, or WO 2011/107215 A.

In another aspect, the present invention relates to a method for preparing the color conversion film (100), wherein the method comprises the following sequential steps of:

(a) preparing a red ink comprising nanosized 1^{st} red color converting material (111) and nanosized 2^{nd} red color converting material (112), and solvent; and a green ink comprising nanosized 1^{st} green color converting material (121) and nanosized 2^{nd} green color converting material (122), and solvent;

(b) providing the resulting inks from step (a) onto the red sub color area (110), and green sub color area (120); and

(c) evaporating the solvent in the coated inks to provide the color conversion film (100).

In a preferred embodiment of the present invention, the red ink further comprises a matrix material and the green ink further comprises a matrix material.

Type of matrix material is not particularly limited. Many kinds of matrix materials such as photo polymerizable polymers can be used preferably as desired.

According to the present invention, inkjet printing method is more preferable to provide the inks onto the red and green sub color area of the color conversion film (100) accurately.

Without wishing to be bound by theory, it is believed that inkjet printing method may lead to less consumption of color converting material because the inkjet method can control the amount of ink during the ink jetting process accurately.

In another aspect, the present invention also relates to a method for preparing the optical device (160), wherein the method comprises the following step (x):

(x) providing the color conversion film (100) into the optical device (160).

In some embodiment of the present invention, the method further can comprise step (y):

(y) adjusting position of the color conversion film (100) with the alignment maker.

Actual alignment method is not particularly limited. Publically known alignment technique can be used preferably.

The invention is described in more detail in reference to the following examples, which are only illustrative and do not limit the scope of the invention.

### Examples

### Example 1

In this example, one embodiment of the color conversion film (100) of the present invention is disclosed.

As the nanosized 1^{st} and 2^{nd} red color converting materials, for example, quantum dot which can emit light having peak wavelength 620 nm (FWHM less than 40 nm, product number 790192, Sigma Aldrich) and quantum dot (FWHM less than 40 nm, 630 nm peak wavelength, product number 790206, Sigma Aldrich) can be used.

And as the nanosized 1^{st} and 2^{nd} green color converting materials, for example, quantum dot which can emit light having peak wavelength 520 nm (FWHM less than 40 nm, product number 748021, Sigma Aldrich), and quantum dot (FWHM less than 40 nm, 540 nm peak wavelength, product number 748056, Sigma Aldrich) can be used.

### Example 2

FIG. 2 shows one example of the present invention.

In this example, a liquid crystal element is used with blue light source and the color conversion layer.

### Example 3

FIG. 3 shows another example of the present invention.

In this example, MEMS shutter is used preferably.

### Example 4

FIG. 4 shows one example of the optical device of the present invention. In this example, the color conversion film and color filter comprise two alignment makers each independently. These alignment makers can be used to align the color conversion film to an optical device especially to a color filter of the optical device accurately.

Each feature disclosed in this specification, unless stated otherwise, may be replaced by alternative features serving the same, equivalent, or similar purpose. Thus, unless stated otherwise, each feature disclosed is but one example of a generic series of equivalent or similar features.

### Definition of Terms

According to the present invention, the term “transparent” means at least around 60% of incident light transmittal at the thickness used in a polarized light emissive device and at a wavelength or a range of wavelength used during operation of a polarized light emissive device. Preferably, it is over 70%, more preferably, over 75%, the most preferably, it is over 80%.

The term “fluorescence” is defined as the physical process of light emission by a substance that has absorbed light or other electromagnetic radiation. It is a form of luminescence. In most cases, the emitted light has a longer wavelength, and therefore lower energy, than the absorbed radiation.

The term “semiconductor” means a material which has electrical conductivity to a degree between that of a conductor (such as copper) and that of an insulator (such as glass) at room temperature.

The term “inorganic” means any material not containing carbon atoms or any compound that containing carbon atoms ionically bound to other atoms such as carbon monoxide, carbon dioxide, carbonates, cyanides, cyanates, carbides, and thiocyanates.

The term “emission” means the emission of electromagnetic waves by electron transitions in atoms and molecules.

1. A color conversion film (100) comprising a red sub color area (110), a green sub color area (120), and a blue sub color area (130), wherein the red sub color area (110), green sub color area (120), and blue sub color area (130) are each independently or commonly surrounded by a bank (140), wherein the red sub color area (110) comprises nanosized 1^{st} red color converting material (111) and nanosized 2^{nd} red color converting material (112); the green sub color area (120) comprises nanosized 1^{st} green color converting material (121) and nanosized 2^{nd} green color converting material (122); and the blue sub color area (110) does not contain any blue color converting material, wherein the 2^{nd} red color converting material (112) emits light having longer peak wavelength than the peak wavelength of the light from the 1^{st} red color converting material when it is excited; and the 2^{nd} green color converting material (122) emits light having longer peak wavelength than the peak wavelength of the light from the 1^{st} green color converting material when it is excited.

2. The color conversion film (100) according to claim 1, wherein the peak wavelength of the light emission from the nanosized 1^{st} and 2^{nd} red color converting materials are in the range from 610 nm to 640 nm; and the peak wavelength of the light emission from the nanosized 1^{st} and 2^{nd} green color converting materials are in the range from 515 nm to 550 nm.

3. The color conversion film (100) according to claim 1, wherein the nanosized 1^{st} red color converting material (111), nanosized 2^{nd} red color converting material (112), nanosized 1^{st} green color converting material (121), and nanosized 2^{nd} green color converting material (122) are each independently selected from the group consisting of an inorganic fluorescent semiconductor quantum rod, inorganic fluorescent semiconductor quantum dot, and a combination of any of these.

4. The color conversion film (100) according to claim 1, wherein the bank (140) has a tapered shape.

5. The color conversion film (100) according to claim 1, wherein the bank (140) has a reflective layer (150) directly on the surface of the bank.

6. The color conversion film (100) according to claim 1, wherein the color conversion film (100) comprises one or more of alignment maker.

7. Use of the color conversion film according to claim 1 (100) in an optical device.

8. An optical device (160), comprising the color conversion film (100) including a red sub color area (110), green sub color area (120), and blue sub color area (130); a light switching element (170); and a color filter (180); wherein the red sub color area (110), green sub color area (120), and blue sub color area (130) are each independently or commonly surrounded by a bank (140), wherein the red sub color area (110) comprises nanosized 1^{st} red color converting material (111) and nanosized 2^{nd} red color converting material (112); the green sub color area (120) comprises nanosized 1^{st} green color converting material (121) and nanosized 2^{nd} green color converting material (122); and the blue sub color area (110) does not contain any blue color converting material, wherein the 2^{nd} red color converting material (112) emits light having longer peak wavelength than the peak wavelength of the light from the 1^{st} red color converting material when it is excited; and the 2^{nd} green color converting material (122) emits light having longer peak wavelength than the peak wavelength of the light from the 1^{st} red color converting material when it is excited.

9. The optical device (160) according to claim 8, wherein the electro optical device (160) further comprises a blue light source (190).

10. The optical device (160) according to claim 8, wherein the peak wavelength of the light emission from the blue light source (190) is in the range from 425 nm to 466 nm.

11. The optical device (160) according to claim 8, wherein the blue light source (190), the color conversion film (100), the light switching element (170), and the color filter (180) are placed in this sequence.

12. The optical device (160) according to claim 8, wherein the light switching element (170) is selected from the group consisting of a liquid crystal element, Micro Electro Mechanical Systems, electro wetting element, and electrophoretic element.

13. Method for preparing the color conversion film (100), wherein the method comprises the following sequential steps of:
(a) preparing a red ink comprising nanosized 1^{st} red color converting material (111) and nanosized 2^{nd} red color converting material (112), and solvent; and a green ink comprising nanosized 1^{st} green color converting material (121) and nanosized 2^{nd} green color converting material (122), and solvent;
(b) providing the resulting inks from step (a) onto the red sub color area (110), and green sub color area (120); and
(c) evaporating the solvent in the coated inks to provide the color conversion film (100).

14. Method for preparing the optical device (160) according to claim 8, wherein the method comprises the following step (x):
(x) providing the color conversion film (100) into the optical device (160).
